(19) United States
(12) Patent Application Publication
(10) Pub. No.: US 2006/0136694 A1
(43) Pub. Date: Jun. 22, 2006

(54) Techniques to partition physical memory

(76) Inventors: Robert Hasbun, Placerville, CA (US); Dennis M. O'Connor, Chandler, AZ (US); John H. Wilson, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/015,149

(22) Filed: Dec. 17, 2004

(51) Int. Cl. G06F 12/00; G06F 13/00

(52) U.S. Cl. 711/173

(57) ABSTRACT

System, method and apparatus to partition physical memory for a device are described.

### BACKGROUND

A communication system may comprise multiple nodes, with each node having a processing system. The processing system may include, for example, a processor and a memory subsystem. The processing system may assist in communications between the various nodes. In addition, the processing system may be used to execute various application programs, sometimes concurrently. Consequently, the processing system may need to support multiple execution contexts in which multiple sets of independent services and applications are executed. Accordingly, there may be need to manage such multiple execution contexts.

### BRIEF DESCRIPTION OF THE DRAWINGS

FIG. 1 illustrates a block diagram of a system 100.

FIG. 2 illustrates a partial block diagram of a processing system 200.

FIG. 3 illustrates a memory structure 300.

FIG. 4 illustrates a trusted computing base architecture 400.

FIG. 5 illustrates a programming logic 500.

### DETAILED DESCRIPTION

Some embodiments may be arranged to create and manage multiple physical domains for a processing system. For example, the processing system may create multiple physical domains in a memory subsystem, with the domains isolated from each other. The multiple physical domains may be used for any number of operations, such as isolating different execution threads or processes from each other. The multiple physical domains may be managed so that a process running in one physical domain is unable to access the physical memory for a separate physical domain. The embodiments are not limited in this context.

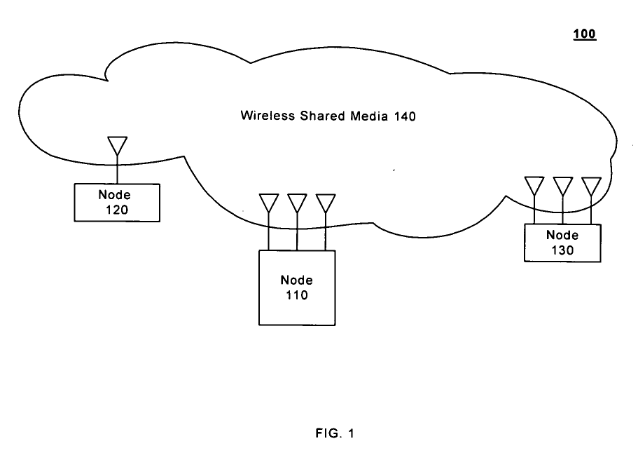

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, telephone, cellular telephone, personal digital assistant (PDA), router, switch, bridge, hub, gateway, wireless access point, and so forth. The unique address may comprise, for example, a network address such as an Internet Protocol (IP) address, a device address such as a Media Access Control (MAC) address, and so forth. The embodiments are not limited in this context.

The nodes of system 100 may be arranged to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disk controller, video controller, audio controller, and so forth. The embodiments are not limited in this context.

When implemented as a wireless system, for example, system 100 may include one or more wireless nodes arranged to communicate information over one or more types of wireless communication media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transmitters/receivers (“transceivers”), amplifiers, filters, control logic, and so forth. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

Referring again to FIG. 1, system 100 may comprise a wireless communication system, having representative nodes 110, 120 and 130. Although FIG. 1 is shown with a limited number of nodes in a certain topology, it may be appreciated that system 100 may include more or less nodes in any type of topology as desired for a given implementation. The embodiments are not limited in this context.

As shown in FIG. 1, system 100 may comprise nodes 110, 120 and 130. In one embodiment, for example, nodes 110, 120 and 130 may comprise wireless nodes arranged to communicate information over a wireless shared media 140. An example of wireless shared media 140 may include RF spectrum. Wireless nodes 110, 120 and 130 may include components and interfaces suitable for communicating information signals over the designated RF spectrum for wireless shared media 140. Examples of a wireless node may include a mobile or cellular telephone, a computer equipped with a wireless access card or modem, a handheld client device such as a wireless PDA, a wireless access point, a base station, a mobile subscriber center, a radio network controller, and so forth. In one embodiment, for example, 110, 120 and/or 130 may comprise wireless devices developed in accordance with the Personal Internet Client Architecture (PCA) by Intel® Corporation, Santa Clara, Calif. Although the embodiments may be illustrated in the context of a wireless communications system, it may be appreciated that the principles discussed herein may also be implemented in a wired communications system as well. The embodiments are not limited in this context.

In one embodiment, nodes 110, 120 and/or 130 may each comprise a processing system. The processing system may include, for example, a processor and a memory subsystem. The processing system may assist in communicating media and control information over wireless shared media 140. In addition, the processing system may be used to execute various operating systems and application programs, sometimes concurrently. Consequently, the processing system may need to support multiple execution contexts in which multiple sets of independent services and applications are executed. These execution contexts may be implemented as collections of processes, in which each process is wholly contained within its own virtual and/or physical address space. This isolation may help ensure that processes do not accidentally or maliciously damage each other. Further, this isolation may ensure that secure information is neither leaked nor stolen across virtual address boundaries.

In one embodiment, the processing system of one or more nodes 110, 120 and 130 may be arranged to include multiple physical domains. More particularly, the processing system may create any number of domains in the memory subsystem, with each domain isolated from the other domains. The multiple physical domains may be used to, for example, isolate different processes from each other. The multiple physical domains may be managed so that a process running in one physical domain is unable to access the physical memory for a separate physical domain.

In one embodiment, various processes may be grouped within a given domain. The processes may be grouped using any type of desired criteria. For example, highly-trusted processes may be executed in a first domain, less-trusted processes may be executed in a second domain, applications using shared data in a third domain, user applications in a fourth domain, high priority applications in a fifth domain, and so forth. The number and types of domains, however, are not limited in this context.

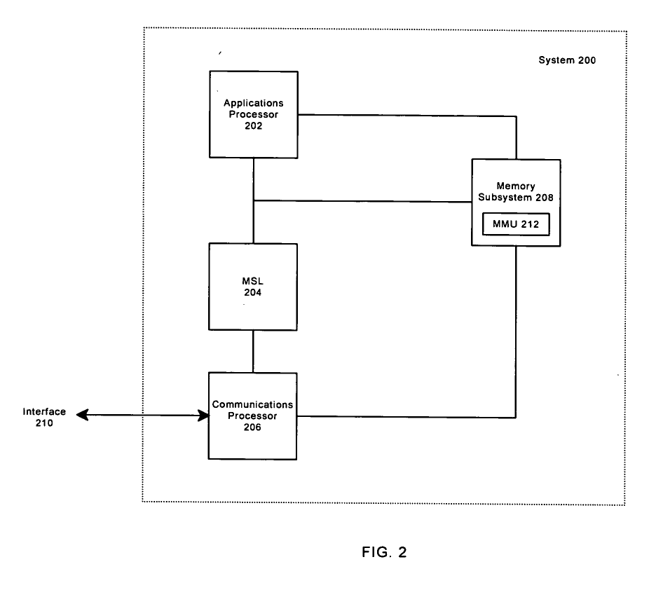

FIG. 2 illustrates a partial block diagram of a processing system 200. Processing system 200 may be representative of a processing system suitable for nodes 110, 120 and/or 130 of system 100 as described with reference to FIG. 1. As shown in FIG. 2, processing system 200 may include multiple elements, such as an applications processor 202, a mobile scalable link (MSL) 204, a communications processor 206, and a memory subsystem 208. Some elements may be implemented using, for example, one or more circuits, components, registers, processors, software subroutines, or any combination thereof. Although FIG. 2 shows a limited number of elements, it can be appreciated that more or less elements may be used in processing system 200 as desired for a given implementation. The embodiments are not limited in this context.

In one embodiment, processing system 200 may include applications processor 202. Applications processor 202 may comprise a general-purpose or special-purpose processor, such as a microprocessor, controller, microcontroller, application specific integrated circuit (ASIC), a programmable gate array (PGA), and so forth. Applications processor 202 may be used to execute various applications, such as data processing operations, modification and manipulation of digital content, and so forth. In one embodiment, for example, a processor may have a reduced instruction set computing (RISC) architecture, such as an architecture based on an Advanced RISC Machines (ARM) architecture. For example, in one embodiment a processor may be a 32-bit version of an XSCALE processor available from Intel Corporation, Santa Clara, Calif. The embodiments are not limited in this context.

In one embodiment, processing system 200 may include MSL 204. MSL 204 may be part of an internal bus connecting applications processor 202 and communications processor 206. MSL 204 may comprise a scalable link having a plurality of gating devices to scalably transfer data between applications processor 202 and communications processor 206. The embodiments are not limited in this context.

In one embodiment, processing system 200 may include communications processor 206. Communications processor 206 may be coupled to applications processor 202 via the internal bus, which may include MSL 204. Communications processor 206 may comprise, for example, a digital signal processor (DSP) based on a micro signal architecture. Communications processor 206 may be used to perform various operations, such as manage wireless communications with external sources via wireless interface 210. In certain embodiments, for example, wireless interface 210 may support General Packet Radio Services (GPRS) or another data service. GPRS may be used by wireless devices such as cellular phones of a 2.5 generation (G) or later generation. The embodiments are not limited in this context.

In one embodiment, processing system 200 may include memory subsystem 208. Memory subsystem 208 may be coupled to both applications processor 202 and communications processor 206. Memory subsystem 208 may include any semiconductor device capable of storing data, including both volatile and non-volatile memory. For example, memory subsystem 208 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, a polymer memory such as ferroelectric polymer memory, an ovonic memory, a phase change or ferroelectric memory, a silicon-oxide-nitride-oxide-silicon (SONOS) memory, magnetic or optical cards, floppy disks, optical disks, compact disk read-only memories (CD-ROMs), compact disk rewritables (CD-RWs), digital video disk (DVD), magneto-optical disks, or any other type of media suitable for storing information. The embodiments are not limited in this context.

In one embodiment, memory subsystem 208 may include a memory management unit (MMU) 212. MMU 212 may be arranged to manage memory operations for memory subsystem 208. For example, MMU 212 may manage a physical memory map for the physical memory of memory subsystem 208, perform address translations, implement an access control policy and caching policy, and so forth. The embodiments are not limited in this context.

It is worthy to note that while processing system 200 is shown as having separate components, it may be appreciated that two or more of the components may be integrated into a single device, such as a single semiconductor device. The embodiments are not limited in this context.

In one embodiment, memory subsystem 208 may be separated into different physical domains. A physical domain may comprise, for example, one or more physical partitions of memory. For example, a physical domain may be directly mapped to a set of physical partitions of memory. A physical partition of memory may comprise one or more sections of contiguous or non-contiguous physical memory.

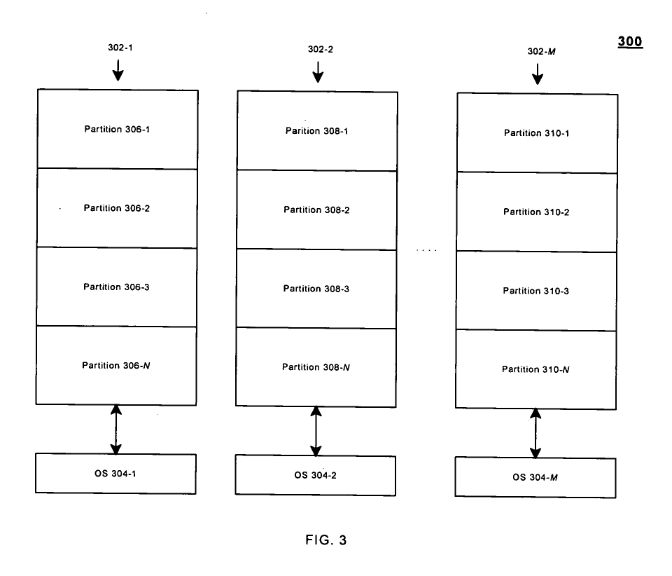

More particularly, applications processor 202 may be used to execute an operating system (OS) for a given node. The OS may comprise, for example, a code base having a reentrant architecture. The OS may separate memory subsystem 208 into multiple physical domains. The multiple physical domains may be used to execute various applications and system services. Multiple physical domains may be created using this architecture which, in certain embodiments, may be based upon functional/logical partitioning. An example of this architecture may be described in more detail with reference to FIG. 3.

FIG. 3 illustrates a memory structure 300. Memory structure 300 may be representative of, for example, a memory structure used by processor 202 for memory subsystem 208. As shown in FIG. 3, memory structure 300 may include multiple physical domains 302-1-M, with M comprising the physical domain count. Each physical domain 302 may be directly mapped to a set of physical partitions of memory. For example, physical domain 302-1 may include partitions 306-1-N, physical domain 302-2 may include partitions 308-1-N, and physical domain 302-M may include partitions 310-1-N, with N comprising the partition count of a physical domain. Each partition may comprise a contiguous or non-contiguous section of physical memory, such as from memory subsystem 208. A partition does not necessarily need to be contiguous with another partition, although that may occur. In addition, each partition may vary in size, and in some cases, the size may be configurable. The embodiments are not limited in this context.

In one embodiment, each physical domain 302 may have a separate OS, such as OS 304-1-M. Each OS 304 may include an OS kernel to perform system management functions, such as memory and file management and allocation of system resources. Alternatively, each OS 304 may be implemented using, for example, a microkernel-based architecture. Although a separate OS 304 is shown for each physical domain 302 in FIG. 3, it may be appreciated that a single OS 304 may be used for all physical domains 302-1-M, or any combination thereof. The embodiments are not limited in this context.

In one embodiment, each physical domain 302 may include one or more processes and/or data. A process may comprise programming code executed by a processor, such as processor 202, for example. Within a given physical domain 302, all physical addressing in the domain may be limited by processor 202 to the physical domain. That is, a given domain is not necessarily allowed to physically address memory spaces outside of the physical partitions that form the physical domain.

In various embodiments, applications and/or services may be segmented in the same physical domain. For example, various applications, interrupt code, processes or threads may be allocated to a given physical domain. The combining of applications and/or services may be accomplished using any desired criteria, such as if the applications are mutually-trusted, if the applications share data, if they are from the same provider, if they are for the same user, if they are for use with different operating systems, and so forth. In such manner, the applications and services in the same physical domain may share memory, thus providing performance gains while maintaining a protection boundary around the set. Examples of mutually-trusted applications may include a word processing application and an email application from the same manufacturer segmented into a single domain, a banking application and an ecommerce application from the same provider, or a Digital Rights Management (DRM) application and content player, and so forth. The embodiments are not limited in this context.

In certain embodiments, for example, physical domains 302 may include a secure physical domain and a non-secure physical domain. For example, physical domain 302-1 may be designated as a secure domain, while physical domain 302-2 may be designated as a non-secure domain. Trusted applications may be executed in secure domain 302-1, and non-trusted applications may be executed in non-secure domain 302-2. An example of non-trusted applications may include certain user applications. If the user applications were to corrupt memory or drivers, the impact would be limited to the user application environment. Examples of secure applications may include downloading of code updates, downloading of secure digital content, authentication code, and so forth. In certain embodiments, for example, a secure domain may include a trusted JAVA™ application, or set of trusted JAVA™ applications and services, that execute in a trusted JAVA™ runtime environment of the secure domain. The embodiments are not limited in this context.

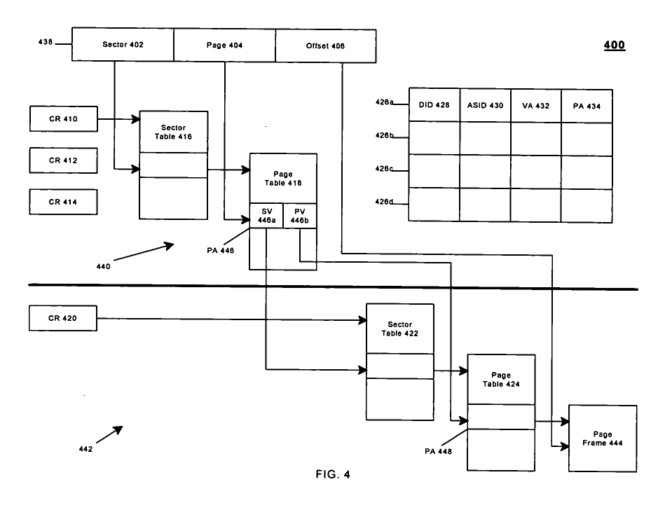

In one embodiment, memory structure 300 may be arranged to operate in accordance with a trusted computing base (TCB) architecture. For example, TCB code may be executed in secure physical domain 302-1. The TCB architecture may isolate processes within a given physical domain, and prevent processes in one domain from accessing the physical memory allocated to another domain. For example, the TCB architecture may cause each OS 304 for each corresponding physical domain 302 to operate as if physical domain 302 begins at a set physical memory location, such as physical memory location zero, for example. This may be accomplished by, for example, creating a set of physical memory addressing tables for each physical domain 302. The physical memory addressing tables receives a physical address generated by a given physical domain 302. The physical address generated by a given physical domain 302 may comprise, for example, a physical address translated from a virtual address using a set of virtual address translation tables. The physical memory addressing tables may map the physical address to a physical page address in physical domain 302. This may be accomplished even though the physical page address may be in a different, and potentially discontiguous, physical domain 302. The TCB architecture may be described in more detail with reference to FIG. 4.

FIG. 4 illustrates a TCB architecture 400. FIG. 4 illustrates a logical view of various memory structures used in performing memory address translations for a processing system 200, such as processing system 200, in accordance with a TCB architecture. More particularly, FIG. 4 may illustrate a memory structure 426, a virtual address 438, a set of virtual address translation tables 440, and a set of physical address translation tables 442. One or more memory structures may be located, for example, in a level one (L1) or level two (L2) cache associated with a processor, such as processor 202. The embodiments are not limited in this context.

In one embodiment, TCB 400 may include memory structure 426. Memory structure 426 may be supported by a cache or other temporary storage of most recently used memory partitions. In one embodiment, memory structure 426 may include a plurality of entries 426a-d. Each entry may include a domain identifier (DID) 428, an address space identifier (ASID) 430, a virtual address (VA) 432, and a physical address (PA) 434. DID 428 may identify a given physical domain, such as one of physical domains 302-1-M. ASID 430 may identify an address space used by physical domain 302. Virtual address 432 may comprise a virtual address generated by processor 202. Physical address 434 may comprise a physical address of memory subsystem 208 associated with virtual address 432. While memory structure 426 is shown in FIG. 4 as having four entries, it may be appreciated that memory structure 426 may have any number of entries in accordance with a desired implementation. The embodiments are not limited in this context.

In one embodiment, TCB 400 may include virtual address 438. Virtual address 438 may comprise an example of a virtual address received by memory subsystem 208. For example, virtual address 438 may be generated by processor 202 on behalf of an application program or OS 304. As shown in FIG. 4, virtual address 438 may include a sector value 402, a page value 404, and an offset value 406. Sector value 402 may comprise an index to a sector table, such as sector table 416. Page value 404 may comprise an index to a page table, such as page table 418. Offset value 406 may be an index into a page frame of physical memory. Memory subsystem 208 may receive virtual address 438 from processor 202, and translate virtual address 438 into a physical address using, for example, virtual address translation tables 440.

In one embodiment, TCB 400 may include virtual address translation tables 440. Virtual address translation tables 440 may be used to implement virtual addressing for processing system 200. Virtual addressing can be useful for managing physical memory for a number of reasons, such as allocating physical memory to different processes with potentially conflicting address maps, allowing an application with a sparse address map to use a contiguous region of physical memory, allowing an application with a contiguous address map to use a collection of non-contiguous regions of physical memory, sharing a limited memory resource between multiple applications, implementing virtual machines, and so forth. In virtual addressing, a virtual address may be mapped to a physical address in main memory. The physical address may identify which physical memory location is being accessed. Virtual address translations tables 440 may be used to translate the virtual address to the appropriate physical address.

In one embodiment, TCB 400 may include physical address translation tables 442. Physical address translation tables 442 may receive a first physical address from virtual address translation tables 440. Physical address translation tables 442 may translate the first physical address to a second physical address by performing a translation table walk of sector table 422 and page table 424, for example. The second physical address may comprise, for example, a start address for a physical page frame or segment, such as page frame 426. The second physical address may be used in conjunction with offset value 406 to retrieve the actual data requested by processor 202 from page frame 426. In one embodiment, physical address translation tables 442 may reside in memory that can only be modified by a highly-trusted process or a secure process.

In one embodiment, processor 202 may include various memory accessing extensions, such as hardware control registers (CR) 410, 412, 414 and 420. Although a limited number of control registers are shown in FIG. 4, it may be appreciated that any number of control registers may be used as desired for a given implementation. The embodiments are not limited in this context.

In one embodiment, CR 410 and CR 414 may comprise control registers for use in performing virtual address translation operations. For example, CR 410 may include a virtual translation table base register (TTBR) value, and CR 414 may include an address space identifier (ASID) value. The virtual TTBR value stored in CR 410 may indicate a start address for virtual address translation tables 440, such as sector table 416, for example. The ASID value may indicate an address space identifier for a given domain.

In one embodiment, CR 412 and CR 420 may comprise control registers for use in managing physical domains 302-1-M. CR 412 and CR 420 are only accessible by the TCB code. The TCB code may be executed in secure domain 302-1, and CR 412 and CR 420 are only accessible when the TCB is executed in secure domain 302-1. The TCB code may set CR 412 with a DID for a current physical domain 302. The DID may comprise any size DID value to accommodate any number of desired domains, such as an 8 bit value that accommodates 256 domains, for example. The TCB code may set CR 420 with the root of the level 1 physical address translation table, such as sector table 422, whenever control is switched from one domain to another domain. Consequently, switching between domains can only be accomplished by the TCB code when in executed in a secure state.

In general operation, virtual address 438 may be translated into a physical address in a translation table walk of sector table 416 and page table 418. For example, processor 202 may request data from memory subsystem 208 using virtual address 438. MMU 212 of memory subsystem 208 may translate virtual address 438 to a physical address. MMU 212 may search a results oriented cache, such as a translation lookaside buffer (TLB) or a domain lookaside buffer (DLB), for memory structure 426. If virtual address 438 matches a virtual address in memory structure 426, such as virtual address 432, then MMU 212 may retrieve the associated physical address, such as physical address 434. In some embodiments, ASID 430 may need to match CR 412 for the virtual address match to occur. In other embodiments, DID 428 may need to match CR 414 for the virtual address match to occur. If there is an appropriate match, MMU 212 may retrieve the data stored at physical address 434, and return the data to processor 202. In this case, translation table walks of virtual address translation tables 440 and/or physical address translation tables 442 may not necessarily be needed.

If virtual address 438 does not match a virtual address in memory structure 426, however, MMU 212 may perform a translation table walk of virtual address translation tables 440. MMU 212 may retrieve a sector value 402 from virtual address 438. MMU 212 may also retrieve a virtual TTBR value from CR 412. MMU 212 may use the virtual TTBR value to locate the start address for sector table 416. MMU 212 may use sector value 402 to index into sector table 416 to find an entry with the appropriate pointer to the start address for page table 418. MMU 212 may retrieve page value 404 from virtual address 438, and use page value 404 to index into page table 418 to find a physical address 446 corresponding to virtual address 438.

In conventional systems, page table 418 may provide the appropriate pointer to a page frame with the actual data needed by processor 202. It may be desirable, however, to remap the physical memory in a manner that is different from the physical memory map originally in place when the physical addresses were stored in page table 418. For example, the new physical memory map may allow for multiple domains, such as memory structure 300 as described with reference to FIG. 3. In such a case, physical address 446 provided by page table 418 may not necessarily provide the correct page frame for the physical memory location storing the actual data needed by processor 202. Consequently, some embodiments may allow processing system 200 to generate a new physical memory map that obviates the need to modify the physical addresses stored in one or more virtual address translation tables 440, such as page table 418, for example. Further, some embodiments may implement the new physical memory map without disrupting operations used by processing system 200 that were associated with the previous physical memory map. In this manner, the various techniques for creating and managing multiple domains may be implemented with conventional or legacy systems.

In some embodiments, for example, MMU 212 may use physical address translation tables 442 to translate physical address 446 provided by page table 418 of virtual address translation tables 440 to a page frame that is part of a new physical memory map for memory subsystem 208. The new physical memory map may reflect, for example, the multiple domains implemented for processing system 200. For example, MMU 212 may use physical address 446 provided by page table 418 to perform a translation table walk of physical address translation tables 442. For example, physical address 446 may comprise a varying number of bits, such as 32-64 bits. The precise size of physical address 446 may be set in accordance with a given implementation. Physical address 446 may be segmented into a sector value 446a and a page table value 446b. Any of the bits comprising physical address 446 may be allocated for sector value 446a and page table value 446b. For example, assume physical address 446 comprises 32 bits. Sector value 446a may comprise 16 bits starting from the most significant bit, and page table value 418b may comprise 16 bits starting from the least significant bit. The actual size for sector value 446a and page table value 446b, however, may vary according to a number of factors, such as the granularity of the physical sector tables and physical page tables, the number of each type of table, the depth or levels of tables, and so forth. The embodiments are not limited in this context.

In one embodiment, physical address translation tables may be used to translate a first physical address 446 to a second physical address 448. Second physical address 448 may comprise, for example, a start address for a physical page frame or segment, such as page frame 426. For example, MMU 212 may retrieve a domain TTBR from CR 420. The domain TTBR may provide the start address or start location for sector table 422 of physical address translation tables 442. MMU 212 may use sector value 446a to index into sector table 422 to find an entry with the appropriate pointer to the start address for page table 424. MMU 212 may use page value 446b to index into page table 424 to find a physical address 448. Physical address 448 may indicate a start address and/or page frame number for page frame 426. MMU 212 may retrieve offset value 406 to index into page frame 426 to retrieve the actual data requested by processor 202 using virtual address 438.

In one embodiment, MMU 212 may be arranged to generate a fault or exception message if physical address 448 is not in the current physical domain as defined by the physical address translation tables. Various routine error handling techniques may be used in response to the exception message. The embodiments are not limited in this context.

In one embodiment, OS 304 may store one or more policies in virtual address translation tables 440. For example, the policies may include an access control policy, a caching policy, and so forth. The TCB code, however, may have its own set of policies recorded in physical address translation tables 442. In one embodiment, processor 202 may be arranged to use the policies recorded in physical address translation tables 442 rather than the policies recorded in virtual address translation tables 440. In this manner, the policies stored in physical address translation tables 442 may supersede or override the policies stored in virtual address translation tables 440. Consequently, processing system 200 may be arranged to perform updated operations as stored in the new policies. For example, the new policy may state that pages having shared code are executed only, no matter what has been specified in virtual address translation tables 440. Accordingly, this may allow the TCB code to safely share code between partitions.

In one embodiment, switching between domains 302 may be controlled by the TCB code. This may be accomplished using, for example, CR 412. CR 412 may include a domain identifier for a secure domain, such as physical domain 302-1. If processor 202 receives a request to switch between physical domains, such as in a context switch, a domain identifier associated with the request may be compared to the domain identifier stored in CR 412. For example, the domain identifier associated with the request may be stored in physical address translation tables 442 for physical domain 302-1. Along with physical address 448, page table 424 may output a domain identifier for use with the request for switching physical domains. The domain identifier from page table 424 may be compared to the domain identifier stored in CR 412. If the domain identifiers do not match, a fault or exception condition may occur. If the domain identifiers do match, however, processor 202 may switch from one physical domain to another physical domain. Thus, switching between physical domains can be limited by the TCB code when executing in secure physical domain 302-1. More particularly, MMU 212 may switch between physical domains only while in a defined domain. Further, the defined domain may comprise a physical domain other than a current physical domain or a target physical domain.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

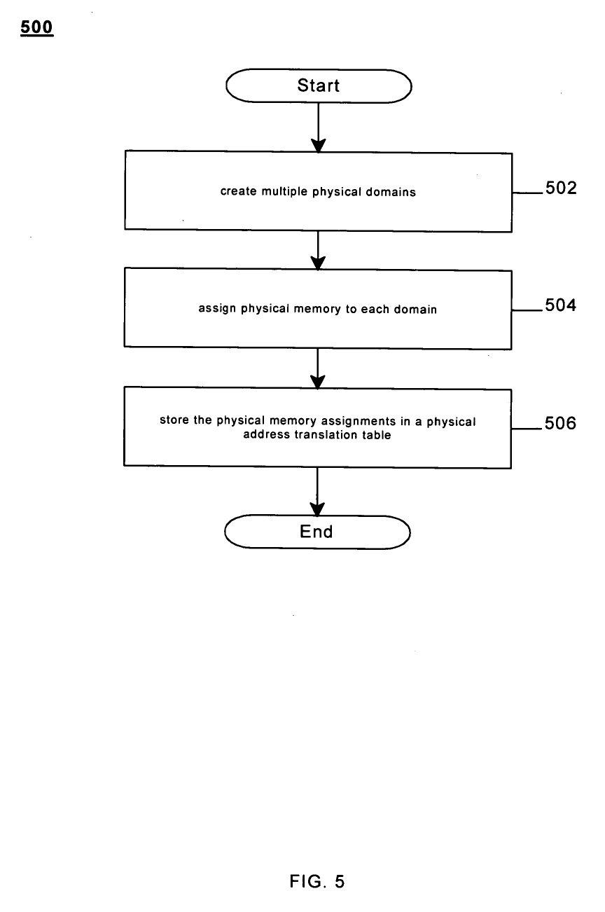

FIG. 5 illustrates a programming logic 500. Programming logic 500 may be representative of the operations executed by one or more systems described herein, such as system 100 and/or system 200. As shown in programming logic 500, multiple physical domains may be created at block 502. Applications and/or system processes may be allocated into the different physical domains potentially based on the criteria as previously described. Physical memory may be assigned to each domain at block 504. The physical memory assignments may be stored in a physical address translation table at block 506.

In one embodiment, various applications, interrupt code, data-set, or processes may be allocated to various domains. For example, a first application, interrupt code, data-set, or process may be allocated into a domain. A second application, interrupt code, data-set, or process may then be allocated into the domain.

In one embodiment, data may be accessed using the physical address translation table. In another embodiment, an application, interrupt code, or process may be executed in a physical domain using the physical address translation table.

In one embodiment, for example, a virtual address may be generated. The virtual address may be translated to a first physical address using a virtual address translation table. The first physical address may be translated to a second physical address using the physical address translation table. An exception may be generated if the second physical address fails to reside in the domain.

In one embodiment, a domain identifier may be retrieved from a first control register. A physical domain may be switched to another physical domain using the domain identifier.

In one embodiment, a physical translation table base register value may be retrieved from a second control register. A start address for the physical address translation table may be determined using the physical translation table base register value.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a memory subsystem having physical memory; and
a processor to connect to said memory subsystem, said processor to create multiple domains, assign each domain a portion of said physical memory, and store said physical memory assignments in a physical address translation table.

2. The apparatus of claim 1, wherein said processor is to access data in a domain using said physical address translation table, or execute an application, process, or interrupt code in a domain using said physical address translation table.

3. The apparatus of claim 1, wherein said processor is to assign contiguous and non-contiguous portions of said physical memory to a domain.

4. The apparatus of claim 1, wherein said memory subsystem includes a memory management unit, said memory management unit to receive a first physical address, and translate said first physical address to a second physical address using said physical address translation table.

5. The apparatus of claim 4, wherein said processor is to generate a virtual address, and said memory management unit is to translate said virtual address to said first physical address using a virtual address translation table.

6. The apparatus of claim 4, wherein said processor is to generate an exception if said physical address does not reside in said domain.

7. The apparatus of claim 4, further comprising a first control register having a domain identifier.

8. The apparatus of claim 7, said memory management unit to switch between said physical domains using said domain identifier.

9. The apparatus of claim 7, wherein said memory management unit is to switch between said physical domains while in a defined domain.

10. The apparatus of claim 9, wherein said defined domain comprises a physical domain other than a current physical domain or a target physical domain.

11. The apparatus of claim 3, further comprising a second control register having a physical translation table base register value, said memory management unit to determine a start address for said physical address translation table using said physical translation table base register value.

12. A system, comprising:
an antenna;
a transceiver to connect to said antenna; and
a processing system to connect to said transceiver, said processing system including a processor and a memory subsystem, said memory subsystem to include physical memory, said processor to create multiple domains, assign each domain a portion of said physical memory, and store said physical memory assignments in a physical address translation table.

13. The system of claim 12, wherein said processor is to access data in a domain using said physical address translation table, or execute an application, process, or interrupt code in a domain using said physical address translation table.

14. The system of claim 12, wherein said processor is to assign contiguous and non-contiguous portions of said physical memory to a domain.

15. The system of claim 12, wherein said memory subsystem includes a memory management unit, said memory management unit to receive a first physical address, and translate said first physical address to a second physical address using said physical address translation table.

16. The system of claim 15, wherein said processor is to generate a virtual address, and said memory management unit is to translate said virtual address to said first physical address using a virtual address translation table.

17. The system of claim 15, wherein said processor is to generate an exception if said physical address does not reside in said domain.

18. The system of claim 15, further comprising a first control register having a domain identifier.

19. The system of claim 18, said memory management unit to switch between said physical domains using said domain identifier.

20. The system of claim 18, wherein said memory management unit is to switch between said physical domains while in a defined domain.

21. The system of claim 20, wherein said defined domain comprises a physical domain other than a current physical domain or a target physical domain.

22. The system of claim 15, further comprising a second control register having a physical translation table base register value, said memory management unit to determine a start address for said physical address translation table using said physical translation table base register value.

23. A method, comprising:
creating multiple physical domains;
assigning physical memory to each domain; and
storing said physical memory assignments in a physical address translation table.

24. The method of claim 23, further comprising accessing data using said physical address translation table.

25. The method of claim 23, further comprising executing an application, interrupt code, or process in a domain using said physical address translation table.

26. The method of claim 23 further comprising allocating a first application, interrupt code, data-set, or process to a domain.

26. The method of claim 23 further comprising allocating a second application, interrupt code, data-set, or process to said domain.

27. The method of claim 23, further comprising:
receiving a first physical address for said application; and
translating said first physical address to a second physical address using said physical address translation table.

28. The method of claim 23, further comprising generating an exception if said physical address fails to reside in said domain.

29. The method of claim 23, further comprising:
generating a virtual address; and
translating said virtual address to said first physical address using a virtual address translation table.

30. The method of claim 23, further comprising:
retrieving a domain identifier from a first control register; and
switching between said physical domains using said domain identifier.

31. The method of claim 23, further comprising:
retrieving a physical translation table base register value from a second control register; and
determining a start address for said physical address translation table using said physical translation table base register value.

32. An article, comprising:
a storage medium;
said storage medium including stored instructions that, when executed by a processor, are operable to create multiple physical domains, assign physical memory to each domain, and store said physical memory assignments in a physical address translation table.

33. The article of claim 32, wherein the stored instructions, when executed by a processor, are further operable to access data using said physical address translation table.

34. The article of claim 32, wherein the stored instructions, when executed by a processor, are further operable to execute an application, interrupt code, or process in a domain using said physical address translation table.

35. The article of claim 32, wherein the stored instructions, when executed by a processor, are further operable to allocate a first application, interrupt code, data-set, or process into a domain.

36. The article of claim 32, wherein the stored instructions, when executed by a processor, are further operable to allocate a second application, interrupt code, data-set, or process into a domain.

37. The article of claim 32, wherein the stored instructions, when executed by a processor, are further operable to receive a first physical address for said application, and translate said first physical address to a second physical address using said physical address translation table.

38. The article of claim 32, wherein the stored instructions, when executed by a processor, are further operable to generate an exception if said physical address fails to reside in said domain.

39. The article of claim 32, wherein the stored instructions, when executed by a processor, are further operable to receive a first physical address for said application, and translate said first physical address to a second physical address using said physical address translation table.

40. The article of claim 32, wherein the stored instructions, when executed by a processor, are further operable to generate a virtual address, and translate said virtual address to said first physical address using a virtual address translation table.

41. The article of claim 32, wherein the stored instructions, when executed by a processor, are further operable to retrieve a domain identifier from a first control register, and switch between said physical domains using said domain identifier.

42. The article of claim 32, wherein the stored instructions, when executed by a processor, are further operable to retrieve a physical translation table base register value from a second control register, and determine a start address for said physical address translation table using said physical translation table base register value.
